(19) United States
(12) Patent Application Publication
(10) Pub. No.: US 2002/0173274 A1
(43) Pub. Date: Nov. 21, 2002

(54) Talking-Paper

(76) Inventors: Cyrus Haghkar, Exton, PA (US); Zahra L. Haghkar, Exton, PA (US)

Correspondence Address: Cyrus Haghkar, Zahra L. Haghkar, 122 Neyland Ct., Exton, PA, 19341, US

(21) Appl. No.: 09/861,503

(22) Filed: May 21, 2001

(51) Int. Cl. H04B 7/00

(52) U.S. Cl. 455/66; 455/186.1

(57) ABSTRACT

The invention relates to a headphone and or a light portable radio receiving certain controllable frequency such as FM or SW for listening to newspapers, or journals or magazines only. This new idea would revolutionize the concept of newspaper reading, instead of sitting and reading newspapers or journals, you can listen to newspapers by a headphone or light portable radio, while accomplishing other tasks, (work) resulting in saving time and increasing workability, using less energy saving your eyes and faster information transmitting.

### BACKGROUND OF THE INVENTION

First time, during February. 1998 it came to my mind, since I was receiving newspapers and magazines at my home door and had no time to read them, all were trashed without looking at them, and I thought would be nice at least to hear their message in this fast paste technology time, and I am driving 2-4 hours everyday on the roads, wouldn't be nice if somebody read the paper for me while I am driving or my favorite article or magazine.

I prepared the new idea and at Apr. 4, 1998 sent to P.T.O. document disclosure form #433894 dated Apr. 9, 1998. Again received doc. disclosure form #472231 dated Apr. 7, 2000 (copies are attached).

This invention is a small lightweight radio receiver that is locked at certain frequencies, so you can listen to your newspaper everyday, anywhere, anytime, can listen to their favorite newspaper while performing their job, operators, technicians, athletes while exercising, drivers, patients in a hospital, older people who have weak eyesight, blind people, all can benefit from this invention (Talking-Paper). Publishers can save millions on paper. The environmental protection value of this invention is unspeakable by saving trees and veggies involve in making papers. You can buy it at the same price and same place the newspapers are sold, newsstands or through order by mail—people who buy newspaper or magazines and not have time to read they buy this new Talking Paper.

### SUMMARY OF THE INVENTION

Talking-Paper, is available in two kinds, 1-headphone type, 2-lightwaight portable radio:

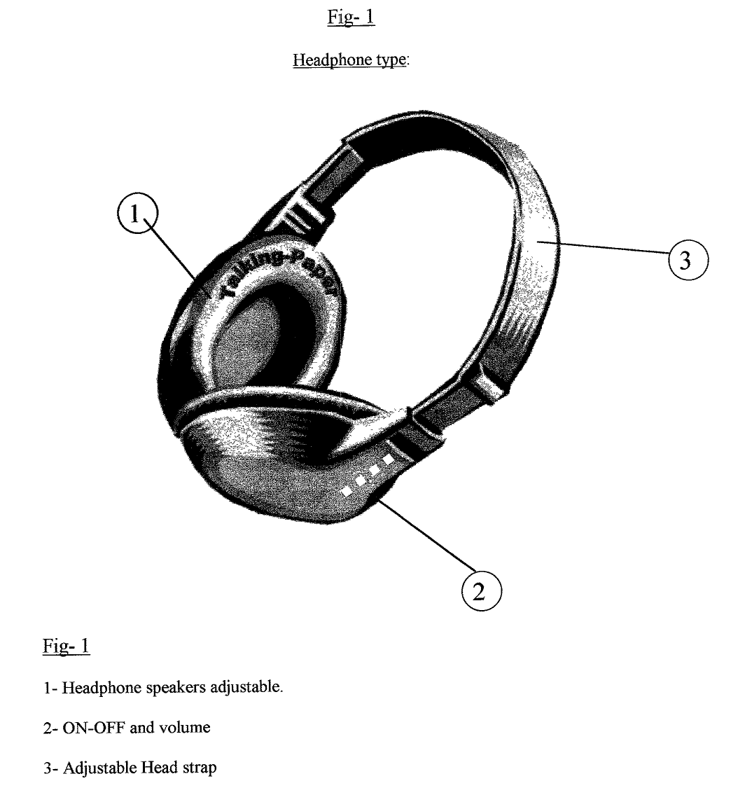

1. Headphone Types as illustrated. By FIG. 1 . . . Pg4 . . . consists of a headphone receiver, on/off and volume switch. You can use it for one month, return and buy another month. It is locked to that month frequency only cost same as buying one month of paper.

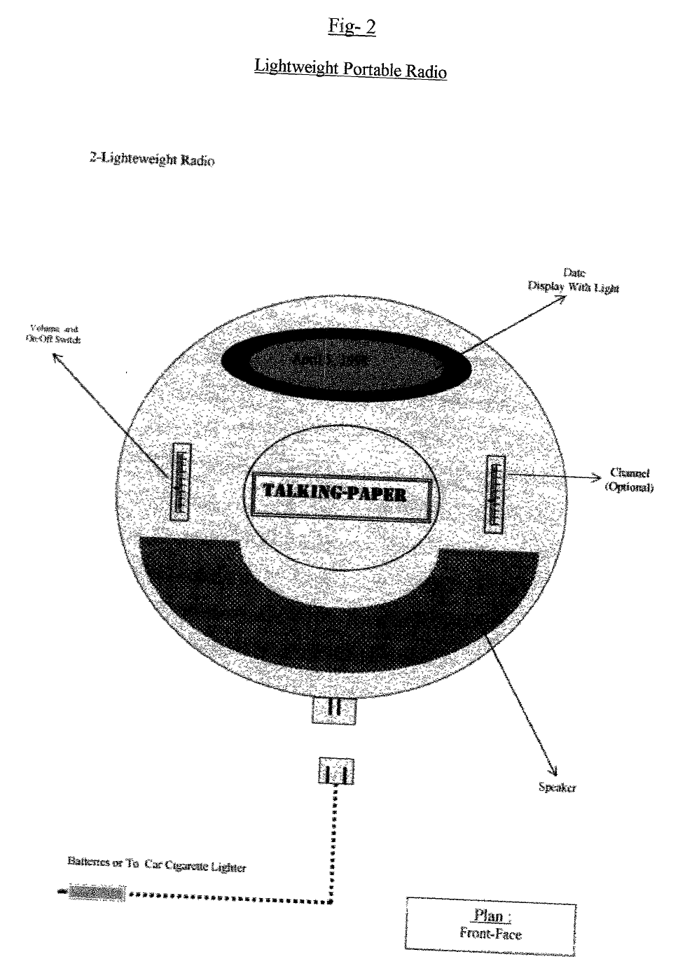

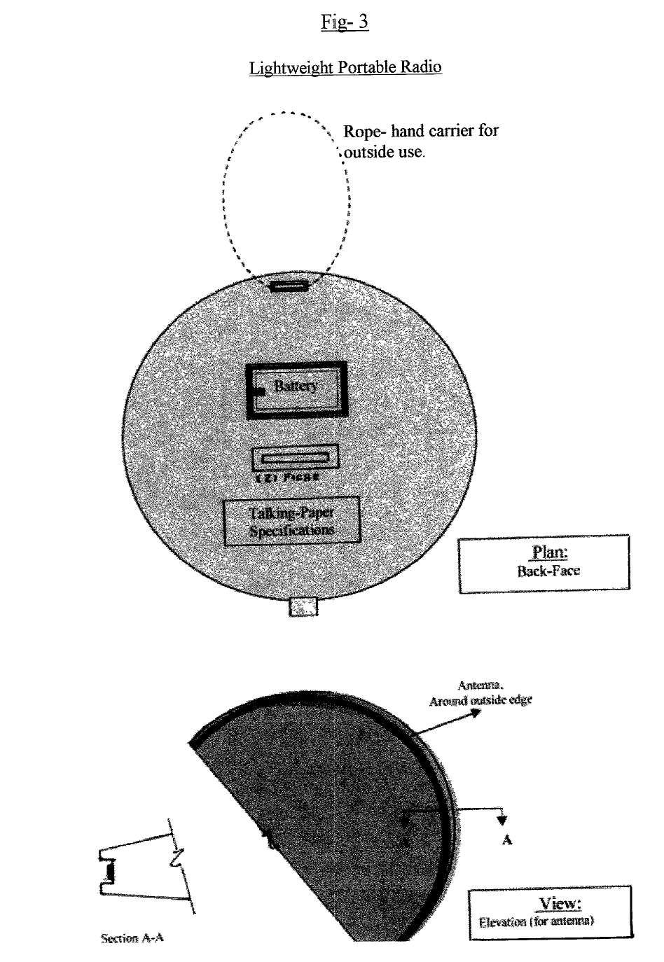

2. Lightweight portable receiver type as illustrated in FIGS. 2-3 . . . Pg 5-6 . . . Includes A—lighted current date, -B—Volume and on/off -C—channel or sections switch, -D—Fiche plug -G—Antenna at round edge as designed radio type are usable all year around as far as you buy monthly or yearly fiche cartridge you can plug it in, in order to activate your receiver. It locks to certain frequency for that month or year only.

Power: Both can be powered by three ways: 1. Battery 2. Auto cigarette lighter. 3. Building Electricity receptacles.

Good point of above all benefits is at this time technology can be made very light, portable and reusable, anywhere, any time, even under your pillow at bed time you can hear your favorite articles.

### Designing the Cartridge for one Time Use

The cartridge can be designed in two ways, for one time use purpose:

1. Placing a spring at the end of each hole it would break when it is used for the first time and it dose not lock or hold for the second time.

2. The second option is to use an electronic timer installed in the radio that disconnects the specific frequency level at a certain time. (See illustration for detail)

We claim:

1. Talking-Paper is a new device that is a light radio receiver that locks on certain frequency to listen to certain newspaper or magazine, or journals, or university lectures.

2. Talking-Paper can be made very light and portable in different shapes, such as headphone type, lightweight radio, small thin under pillow type radio receiver with external antenna, or wrist band type you can use while you are driving your car or jogging outside.

3. Talking Paper is made by plastic and electronic components and chips and fiche cartridge and different parts as follow:

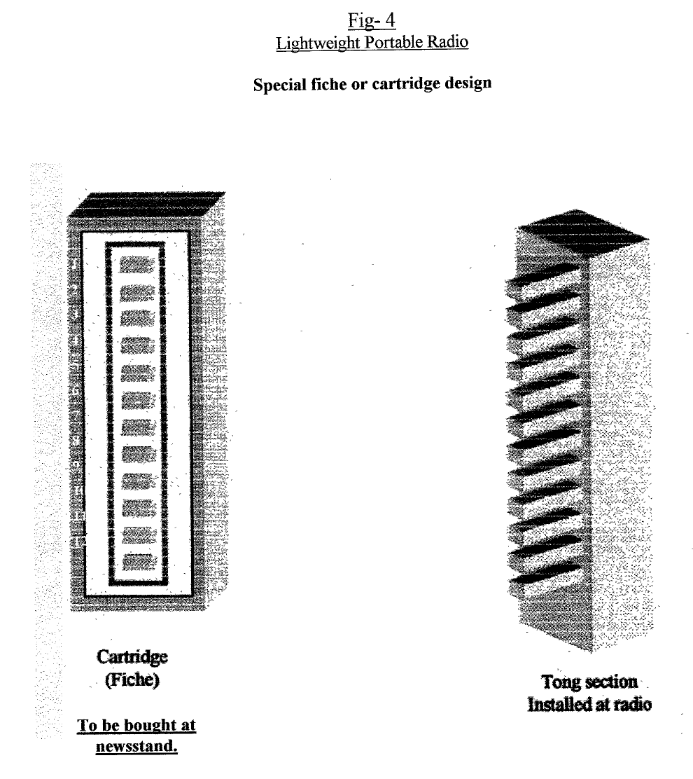

4. A. Plastic body case and board to put components together.
B. On/off and volume switch.
C. Channel or sections switch to connect to different sections of newspaper (All, or A-1-2-3-4-5).
D. Light to display the date (current newspaper date).
E. Label the name of newspaper or magazine companies.
F. Electricity hook-up plug (three way power).
G. Back of radio receiver battery case.
H. Fiche cartridge plug is installed at radio case as FIG. 4 pg-7 and has twelve points each point connect one month for receiving certain frequency at that certain month, only. Or you can pay more and buy the one that connects all 12 holes and you can receive all frequencies for 12 months (one year only).
I. Electronic fiche cartridge receptacle to buy monthly or yearly at newspaper stand to activate and connect to radio plug, to activate your receiver to certain frequency and certain time. You can buy this cartridge where ever news papers are sold this special design cartridge has twelve holes for twelve months each hole connects, locks to certain frequency and certain months only (not reusable). For example hole number one connects the month of January and receives frequency 2001 only, hole number two connects to the month of February and frequency 2002 only, or you can pay for a whole year and the cartridge would connect all twelve holes for the full year.
J. Antenna around edge of receiver and or external antenna.
K. Label specification and patent #, and manufactured by companies.
L. Rope attached to case as a hand carrier for outside use.

5. There are a few ways for transmitting radio frequencies through the air:
A. Communication companies like AT&T and MCI, or US sprint can join newspaper companies and transmit frequencies through their satellites.
B. Local radio stations can also transmit at a certain frequency by having a compact disc from newspaper publishing companies every day.
